(19) United States
(12) Patent Application Publication
(10) Pub. No.: US 2020/0160191 A1
(43) Pub. Date: May 21, 2020

(54) SEMI-AUTOMATED CORRECTION OF POLICY RULES

(71) Applicant: INTERNATIONAL BUSINESS MACHINES CORPORATION, Armonk, NY (US)

(72) Inventors: Theodora BRISIMI, Dublin (IE); Radu MARINESCU, Dublin (IE); Akihiro KISHIMOTO, Castleknock (IE); Vanessa LOPEZ GARCIA, Dublin (IE)

(73) Assignee: INTERNATIONAL BUSINESS MACHINES CORPORATION, Armonk, NY (US)

(21) Appl. No.: 16/194,621

(22) Filed: Nov. 19, 2018

(51) Int. Cl. G06N 5/02; G06N 20/00; G06F 17/27; G06F 16/2457

(52) U.S. Cl. CPC G06N 5/025; G06N 20/00; G06F 16/24578; G06F 17/277; G06F 17/2705; G06F 17/2785

(57) ABSTRACT

Various embodiments are provided for correcting policy data in a computing environment by a processor. Incorrect data of one or more rules extracted from one or more segments of text data may be revised to maintain accuracy and correctness of the policy data source according to an active learning operation.

### BACKGROUND OF THE INVENTION

### Field of the Invention

The present invention relates in general to computing systems, and more particularly to, various embodiments for correcting policy rules using a computing processor.

### Description of the Related Art

Computing systems may be found in the workplace, at home, or at school. Computer systems may include data storage systems, or disk storage systems, to process and store data. Large amounts of data have to be processed daily and the current trend suggests that these amounts will continue being ever-increasing in the foreseeable future. Due to the recent advancement of information technology and the growing popularity of the Internet, a vast amount of information is now available in digital form. Such availability of information has provided many opportunities. Digital and online information is an advantageous source of business intelligence that is crucial to an entity's survival and adaptability in a highly competitive environment. Also, many businesses and organizations, such as financial institutions, employing the use of computing systems and online data must ensure operations, practices, and/or procedures are in compliance with general business protocols, corporate compliance, and/or legal regulations, policies, or requirements.

### SUMMARY OF THE INVENTION

Various embodiments for correcting policy data in a computing environment by a processor are provided. In one embodiment, by way of example only, a method for correcting policy data, again by a processor, is provided. Incorrect data of one or more rules extracted from one or more segments of text data may be revised to maintain accuracy and correctness of the policy data source according to an active learning operation.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram depicting an exemplary cloud computing node according to an embodiment of the present invention;

FIG. 2 is an additional block diagram depicting an exemplary cloud computing environment according to an embodiment of the present invention;

FIG. 3 is an additional block diagram depicting abstraction model layers according to an embodiment of the present invention;

FIG. 4 is an additional block diagram depicting various user hardware and computing components functioning in accordance with aspects of the present invention;

FIG. 5 is a flow diagram for correcting policy data in accordance with aspects of the present invention;

FIG. 6 is a diagram depicting a correcting policy data in which aspects of the present invention may be realized; and

FIG. 7 is a diagram depicting a correcting policy data in which aspects of the present invention may be realized.

### DETAILED DESCRIPTION OF THE DRAWINGS

As the amount of electronic information continues to increase, the demand for sophisticated information access systems also grows. Digital or “online” data has become increasingly accessible through real-time, global computer networks. The data may reflect many aspects of topics ranging from scientific, legal, educational, financial, travel, shopping and leisure activities, healthcare, and so forth. Many data-intensive applications require the extraction of information from data sources. The extraction of information may be obtained through a knowledge generation process that may include initial data collection among different sources, data normalization and aggregation, and final data extraction.

Moreover, some entities (e.g., insurance services offered by insurance companies such as, for example, healthcare, auto, home, etc.) are typically accompanied by multiple policies, which describe a number of rules under which these insurance services are applied. Most, if not all, of the policies are typically described in natural language (e.g., “a patient can only claim up to 48 units of physical therapy per year). In one aspect, depending on a type of policy, the policy may contain hundreds/thousands of rules, which may be checked (e.g., a policy document may consists of more than 100 pages). Also, modern automated claim processing systems may rely on some formal encoding of the policy rules. However, existing tools for automatically extracting rules from text are quite noisy and very prone to errors, often resulting in extracting incorrect rules.

As such, the present invention provides for correcting policy rules in a computing environment. In one aspect, a rule extractor may extract a (consistent) set of rules from a selected policy text. An active learning component may identify one or more rules that require/need to be checked by the user. One or more rules may be scored and ranked based on a scoring function that may be customized by the user. The user may be allowed to revise one or more selected rules (e.g., providing user feedback). Thus, the present invention provides for a semi-automated system for updating policy rules, which were automatically extracted from natural language text, by means of active learning and user feedback.

In one aspect, incorrect data (e.g., incorrect structure and/or incorrect semantic data) of one or more rules extracted from one or more segments of text data may be revised to maintain accuracy and correctness of the policy data source according to an active learning operation. The active learning may be applied to a previously extracted set of consistent rules that may not be accurate (or complete) and requests from the user to revise, correct, update, and/or modify the rules, starting with the rules that have a most significant impact as defined by a user/entity (according to some user defined criteria or to otherwise maximize accuracy in a knowledge base “KB” or knowledge domain). Active learning may be used to learn how to modify similar incorrect rules into accurate rules and modify assigned scores/weights of the rules in the KB. Thus, the active learning may be used to build, maintain, update, and/or construct the KB. In this way, correcting rules may be employed using active learning.

Also, as used herein term “domain” is a term intended to have its ordinary meaning. In addition, the term “domain” can include an area of expertise for a system or a collection of material, information, content and/or other resources related to a particular subject or subjects. For example, a domain can refer to a regulatory, legal, policy, governmental, financial, healthcare, advertising, commerce, scientific, industrial, educational, medical, biomedical-specific information, or other area or information defined by a subject matter expert. A domain can refer to information related to any particular subject matter or a combination of selected subjects.

The term “ontology” is also a term intended to have its ordinary meaning. For example, an ontology may include information or content relevant to a domain of interest or content of a particular class or concept. Content can be any searchable information, for example, information distributed over a computer-accessible network, such as the Internet. A concept or topic can generally be classified into any of a number of content concepts or topics which may also include one or more sub-concepts and/or one or more sub-topics. Examples of concepts or topics may include, but are not limited to, regulatory compliance information, policy information, legal information, governmental information, business information, educational information, or any other information group. The ontology can be continuously updated with the information synchronized with the sources, adding information from the sources to the ontology as models, attributes of models, or associations between models within the ontology.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

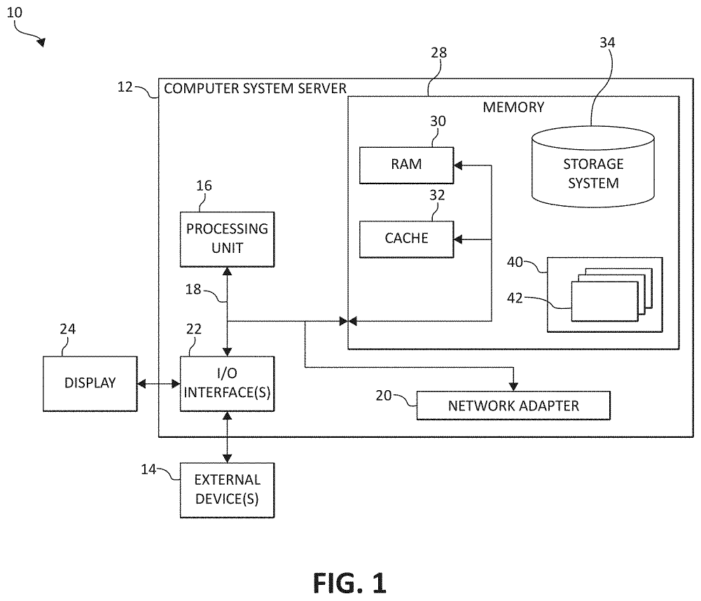

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32.

Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, system memory 28 may include at least one program product having a set (e.g., at least one) of program modules that are configured to carry out the functions of embodiments of the invention.

Program/utility 40, having a set (at least one) of program modules 42, may be stored in system memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

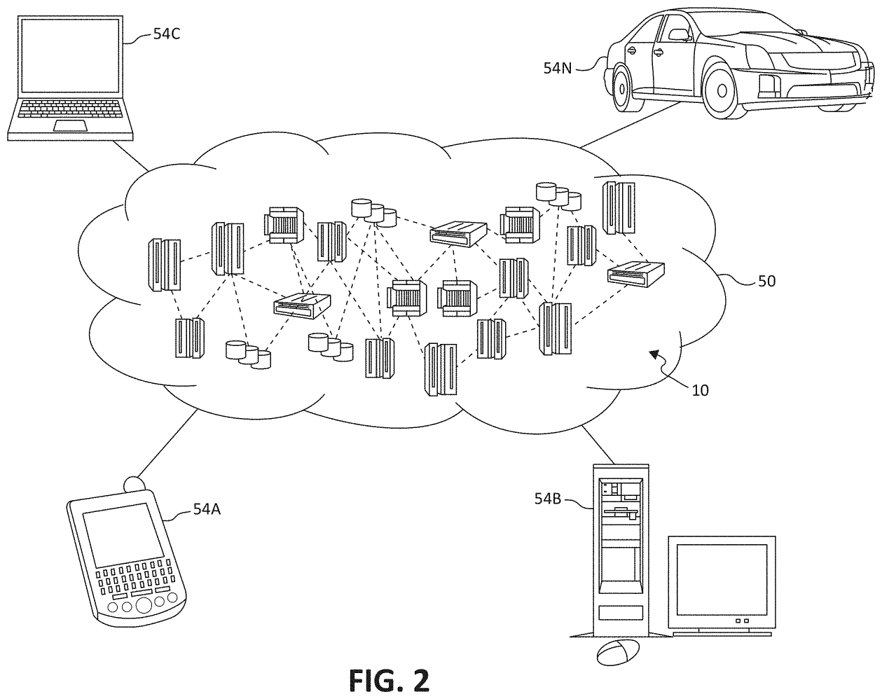

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

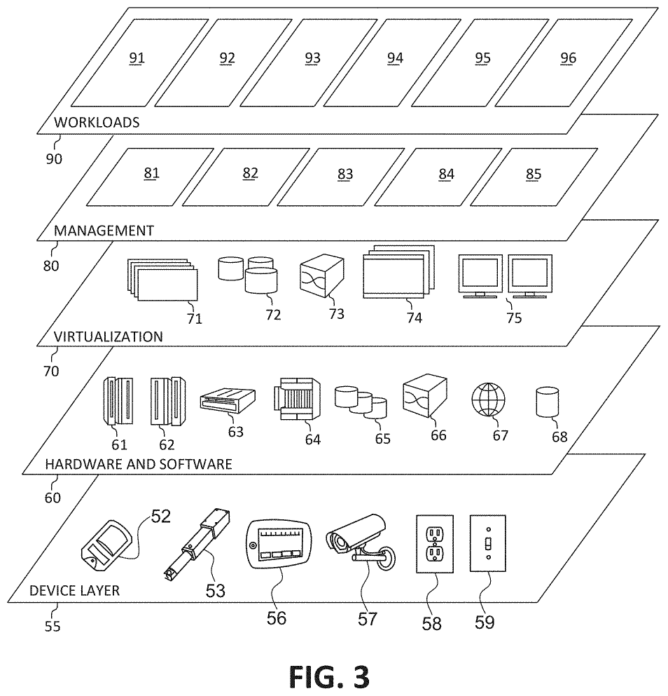

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Device layer 55 includes physical and/or virtual devices, embedded with and/or standalone electronics, sensors, actuators, and other objects to perform various tasks in a cloud computing environment 50. Each of the devices in the device layer 55 incorporates networking capability to other functional abstraction layers such that information obtained from the devices may be provided thereto, and/or information from the other abstraction layers may be provided to the devices. In one embodiment, the various devices inclusive of the device layer 55 may incorporate a network of entities collectively known as the “internet of things” (IoT). Such a network of entities allows for intercommunication, collection, and dissemination of data to accomplish a great variety of purposes, as one of ordinary skill in the art will appreciate.

Device layer 55 as shown includes sensor 52, actuator 53, “learning” thermostat 56 with integrated processing, sensor, and networking electronics, camera 57, controllable household outlet/receptacle 58, and controllable electrical switch 59 as shown. Other possible devices may include, but are not limited to various additional sensor devices, networking devices, electronics devices (such as a remote control device), additional actuator devices, so called “smart” appliances such as a refrigerator or washer/dryer, and a wide variety of other possible interconnected objects.

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, various workloads and functions 96 for correcting policy rules. In addition, workloads and functions 96 for correcting policy rules may include such operations as analytics, entity and obligation analysis, and as will be further described, user and device management functions. One of ordinary skill in the art will appreciate that the workloads and functions 96 for correcting policy rules may also work in conjunction with other portions of the various abstractions layers, such as those in hardware and software 60, virtualization 70, management 80, and other workloads 90 (such as data analytics processing 94, for example) to accomplish the various purposes of the illustrated embodiments of the present invention.

As previously mentioned, the present invention provides a system that may provide semi-automated policy rules correction. A collection of (consistent) policy rules may be received from a policy document. In one aspect, the rules may have been automatically extracted from text such as, for example, a maximum number of units of service that can be provided to the same patient in a period of time, as extracted from policies stored in a knowledge domain/database). At least one rule may be selected having a greatest probability/value (as compared to other rules) as being incorrect and requires a user and/or machine learning to revise, correct, updated, and/or modify the one or more rules. The selected number of rules may be ranked according to a degree of impact (as defined by the user or to maximize a set of criteria, such as coverage or impact of the rule in a given use case such as, for example, a potential recovery costs for policy compliance). That is, the selected rules may be ranked according to a score, which may be defined by the user. For a selected rule, a possible score could be the impact of the rule, i.e., the potential recovery costs if that rule is applied to a collection of claims. A user and/or artificial intelligence (“AI”) operation may be used to revise the rule body.

The system may learn how to discover incorrect rules based on the user feedback. Each rule selected for correction may include a relevant natural text snippet associated with each rule (e.g., a text fragment from which the rules were originally extracted and that may be used to validate the accuracy and completeness of the rule). Each rule may be associated with a weight, indicating confidence in the rule, where users may also (optionally) update the rule weight. The system may provide a collection of corrected rules and corresponding updated weights of each rule. A scoring function may be used that can be defined such as to maximize a set of criteria (e.g., coverage or impact of the rule in a given use case).

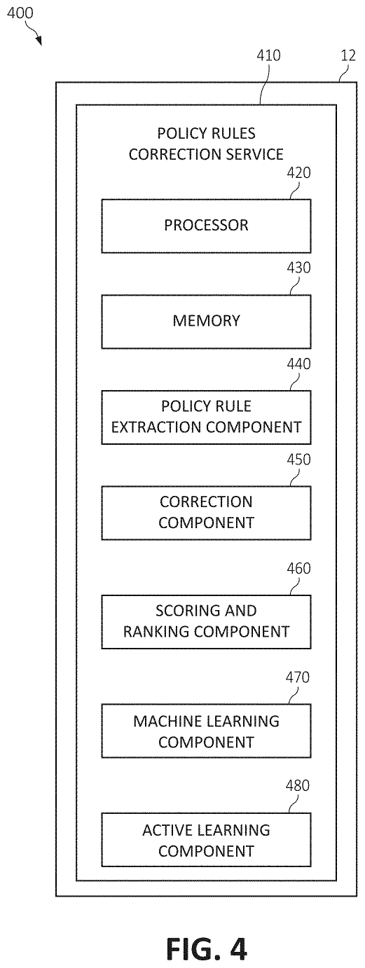

Turning now to FIG. 4, a block diagram depicting exemplary functional components 400 according to various mechanisms of the illustrated embodiments is shown. In one aspect, one or more of the components, modules, services, applications, and/or functions described in FIGS. 1-3 may be used in FIG. 4. A policy rules correction service 410 is shown, incorporating processing unit (“processor”) 420 to perform various computational, data processing and other functionality in accordance with various aspects of the present invention. The policy rules correction service 410 may be provided by the computer system/server 12 of FIG. 1. The processing unit 420 may be in communication with memory 430. The policy rules correction service 410 may include a policy rule extraction component 440, a correction component 450, a scoring and ranking component 460, a machine learning model component 470, and an active learning component 480.

As one of ordinary skill in the art will appreciate, the depiction of the various functional units in policy rules correction service 410 is for purposes of illustration, as the functional units may be located within the policy rules correction service 410 or elsewhere within and/or between distributed computing components.

The policy rule extraction component 440, in association with the active learning component 480, may one or more rules from one or more segments of text data to maintain accuracy and correctness of policy data source according to an active learning operation. The policy rule extraction component 440 may ingest the text data from the policy data source upon processing the text data using a lexical analysis, parsing, extraction of concepts, semantic analysis, a machine learning operation, or a combination thereof, and/or use natural language processing (NLP) to determine the set of rules from one or more segments of text data.

The policy rule extraction component 440, in association with the active learning component 480, identify incorrect data relating to the one or more rules according to a knowledge domain.

The correction component 450 (e.g., a correction service component) may revise and/or correct incorrect data of one or more rules extracted from one or more segments of text data to maintain accuracy and correctness of the policy data source according to an active learning operation. The correction component 450 may modify incorrect data relating to the one or more rules according to a knowledge domain, user feedback, or a combination thereof. The correction component 450 may use one or more modifications to the one or more rules to revise similar rules having incorrect data.

The active learning component 480 may collect feedback from a user for learning modifications to the one or more rules.

The scoring and ranking component 460 may assign a score to the one or more rules indicating a probability of incorrectness. The scoring and ranking component 460 may rank each of the one or more rules according to the assigned score.

The machine learning component 470 may learn, determine, or identify the incorrect data relating to the one or more rules and one or more user-provided modifications to the one or more rules, and/or revise the one or more rules according to collected feedback from a user.

By way of example only, the machine learning component 470 may determine one or more heuristics and machine learning based models using a wide variety of combinations of methods, such as supervised learning, unsupervised learning, temporal difference learning, reinforcement learning and so forth. Some non-limiting examples of supervised learning which may be used with the present technology include AODE (averaged one-dependence estimators), artificial neural networks, Bayesian statistics, naive Bayes classifier, Bayesian network, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting examples of temporal difference learning may include Q-learning and learning automata. Specific details regarding any of the examples of supervised, unsupervised, temporal difference or other machine learning described in this paragraph are known and are considered to be within the scope of this disclosure.

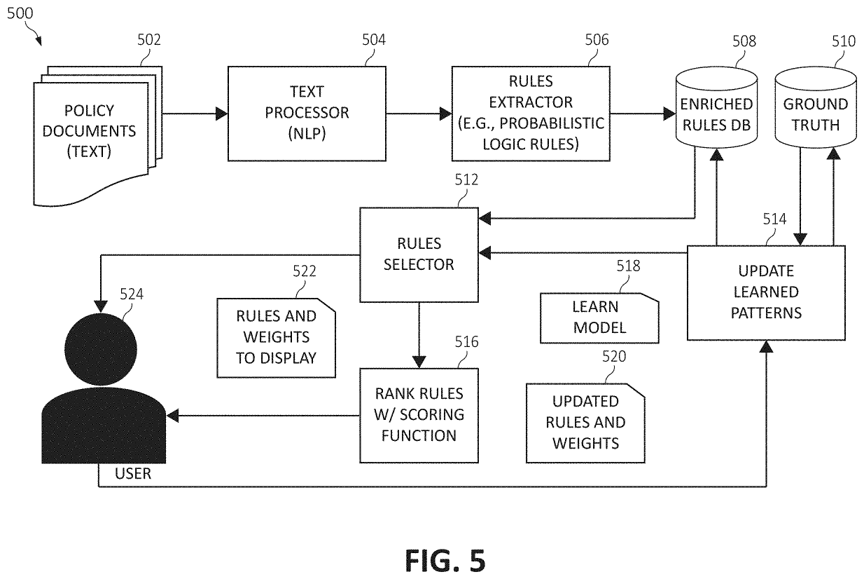

Turning now to FIG. 5, block/flow diagram 500 is depicting for managing regulatory compliance for an entity. In one aspect, one or more of the components, modules, services, applications, and/or functions described in FIGS. 1-4 may be used in FIG. 5. For example, computer system/server 12 of FIG. 1, incorporating processing unit 16, may be used to perform various computational, data processing and other functionality described in FIG. 5.

Also, as shown, the various blocks of functionality are depicted with arrows designating the blocks' 500 relationships with each other and to show process flow. As will be seen, many of the functional blocks may also be considered “modules” or “components” of functionality. With the foregoing in mind, the module blocks 500 may also be incorporated into various hardware and software components of a system for managing regulatory compliance for an entity in accordance with the present invention. Many of the functional blocks 500 may execute as background processes on various components, either in distributed computing components, or on the user device, or elsewhere.

In one aspect, at block 502, text data from one or more policy data sources (e.g., insurance policy documents) may be sent, received, and/or used by natural language processing (“NLP) operation (e.g., a text processor). The NLP operation may ingest text data and detect entities and rules using one or more AI operations and/or NLP processes.

In one aspect, the text data (e.g., an insurance policy document) of one or more policy data sources may be provided by one or more content contributors (e.g., insurance provider/carrier). The one or more data sources may be provided as a corpus or group of data sources defined and/or identified. The one or more data sources may include, but are not limited to, data sources relating to one or more documents, regulatory documents, policy documents, legal documents, materials related to regulatory or legal compliance, emails, books, scientific papers, online journals, journals, articles, drafts, and/or other various documents or data sources capable of being published, displayed, interpreted, transcribed, or reduced to text data. The data sources may be all of the same type, for example, pages or articles in a wiki or pages of a blog. Alternatively, the data sources may be of different types, such as word documents, wikis, web pages, power points, printable document format, or any document capable of being analyzed, ingested, used by a natural language processing (NLP) system and/or artificial intelligence (AI) system to provide processed content. For example, the policy data sources may be processed using a lexical analysis, parsing, extraction of concepts, semantic analysis (e.g., wide-coverage semantic analysis), or a combination thereof and also may be processed to data mine or transcribe relevant information from the content of the policy data sources.

At block 506, a rules extractor component may extract one or more segments (e.g., sentences) with one or more rules/rule-like content/segments (e.g., content having direct or inferential semantics that indicate one or more obligations relating to a rules, law, policy, regulation, or a combination thereof relating to the policy document).

That is, the rules extractor component may extract one or more rules from the ingested text data. In one aspect, the rules extractor component may be a machine learning (“ML”) sentence classifier that determines if a clause is a rules. The extraction of one or more rules/rule-like content/segments (e.g., sentences) may include, but is not limited to, extraction of information through a knowledge generation process that may include initial data collection among different sources (e.g., one or more policy documents).

A database (“DB” or knowledge domain) of rules may be enriched, enhanced, updated, replaced, and/or added to using the extracted rules, as in block 508. That is, the extraction of one or more rules, concepts and topics may include, but is not limited to, performing knowledge extraction from natural language text documents including reading input text; transforming the input text into a machine understandable knowledge representation so as to provide knowledge libraries (e.g., within the database/knowledge domain) from said documents; and using semantic based means for extracting concepts and their interrelations from said input text. Knowledge structures of the database/knowledge domain may be used consisting of rules, or other concepts and topics, such as rule-like obligations and violations, and the interrelations of the rule-like obligations and violations. Hence, the one or more rules having incorrect data relating to the one or more existing, similar rules may be identified according to the database/knowledge domain.

A rules selector may select one or more incorrect rules from the database, as in block 512. A scoring and ranking function, using a rule ranker, may be performed on the selected incorrect rules to score the one or more rules indicating a probability of incorrectness and rank each of the one or more rules according to the assigned score (e.g., weighted values “weights”), as in block 516. The ranked rules and assigned score/weights may be sent to a user, as in block 522.

The user may update the ranked rules and assigned score/weights and other provided user-based feedback relating to the ranked rules and assigned score/weights, as in block 520. The updated, ranked rules and updated, assigned score/weights and other provided user-based feedback may be used to learn and/or updated learned patterns, modifications, changes, and/or to the rules, as in block 512. One or more learned models may be sent back to the rules selector, as in block 518. It should be noted that the “learned model” is a machine learning model that is learned from a set of positive and negative example rules (i.e., correct and incorrect rules). For example, one learned model may be a decision tree or an artificial neural network (“ANN”) that takes as input a rule and returns a label such as “correct rule” or “incorrect rule.” The incorrect rules may then be presented to the user. Once the user corrects the rule, then the system can use this feedback from the user to further train and improve the machine learning model.

The revised, modified, and/or correct rules (e.g., by the user 524) may be added to a ground truth set, as in block 510. The ground truth set may also be used to assist with updating the learned patterns (e.g., learned patterns of corrected rules).

To further illustrate the operation of the rule selector of block 512, consider the following example. Assume the rule selector receives as input 1) a set of enriched rules “R” such that each rule has a body, a weight and a text snippet (from which it was extracted), 2) a threshold “T,” 3, a defined boundary (“bound”) K, and/or 4) a learned model. (by a updated learned patters component that updates learnt patterns at block 514). The rule selector may output a subset “C” of rules (of enriched rules “R”) that needs to be checked by the user 502 (i.e., because the rules may be inaccurate/incorrect). During implementation/training phase, in a first selected number of iterations of the rule selector (i.e., a ML classifier is not yet trained), a the first K rules may be randomly selected to display to the user. In the next components/blocks of FIG. 5, the selected rules may be corrected by the user 524 and added to a ground truth set at block 510. One or more of the rules may be randomly selected to display to the user 522 (of block 522) until the ground truth set meets and/or is equal to a pre-defined criteria to ensure that the learning model trained on the ground truth can produce statistical results showing increase efficiency and selection of the incorrect rules. Upon training and learning the model, each subsequent iteration may be performed as illustrated in the following pseudocode:

Let C = { } • For each (Ri, wi) in R do;
Compute probability (p) that (Ri,wi) is to be checked by the user; (e.g.,
using a ML classifier (SVM) trained on positive/negative examples of
rules (ground truth set))
If p >= T then add (Ri,wi) to C and remove it from R
If size(C) > K, break
Return C.
End

In the above pseudocode, “w” is the weight of the rule which reflects a degree of important of the rule. Intuitively, the larger the weight is the more important the rule (e.g., a higher degree of importance). It should be noted that the weight is different from the score that is used to rank the selected rules that presented to the user in order to be corrected. The procedure iterates over a set of rules R. For each rule Ri, a machine learning classifier is used to classify the rule Ri as “correct rule” or “incorrect rule.” If the rule Ri is classified as “incorrect” then the rule Ri is added to another set C. As soon as the size of the C exceeds a user defined bound K, the procedure returns this set C which contains the “incorrect” rules that are going to be presented to the user. It should be noted that a machine learning model may be used that computes the probability that rule Ri is incorrect.

To further illustrate the operation of the rule ranker of block 516, consider the following example. Assume the rule selector receives as input 1) set of rules R such that each rule has a body and a weight, 2) a scoring function F. The rule ranker may output a list of rules R ranked according to the scoring function F. During implementation, R′ may be set equal to the set of rules (e.g., Let R′={ }), and F may be set as a default scoring function that ranks rules based on the probability the rules are incorrect as defined by the machine learning model. In an additional embodiment, the default scoring function F may be giving higher priority to rules that are associated with probability at or above a defined threshold or value (e.g., close to 0.5) (for those rules that correctness/incorrectness is uncertain. Thus, receiving user provided feedback/correction/labelling may increase the ML algorithm's accuracy. For each (Ri, wi) in R, a scoring function F(R) may be determined, (Ri,wi, F(Ri)) may be added to R′, R′ may be sorted in decreasing order of F(Ri) and R′ may be returned. That is, a set of rules R is ranked according to a scoring function F(Ri), which is defined relative to a rule Ri. An example of a scoring function is the probability that rule Ri is incorrect as computed by the machine learning model.

For updating the learned patterns of block 514 (e.g., a learned patterns component), consider the following example. Assume the operations for updating the learned patterns may include receiving as input 1) a set of rules R′ corrected by the user (e.g., containing a possibly corrected body and a possibly corrected weight), 2) a ground truth set of rules. The learned patterns component may output 1) a new/updated trained model to predict probability that a rule is incorrect, 2) one or more rules to be added to the ground truth database (at block 510) and to be used to correct the enriched rules DB (at block 508). During an implementation operation, a corrected number of rules R′ may be added to the ground truth set (at block 510 which may be a set of rules having a defined degree of certainty of label “correct/incorrect”). The corrected rule may be revised/fixed/corrected/updated in the enriched rules DB (at block 508). The learned model (e.g., ML model such as SVM) may be re-trained based on the ground truth (at block 510). The new/updated model may be used by the rule selector (at block 512) to compute for each remaining rule the probability (p) that the rule needs to be checked by the user 524. It should be noted that the learned patterns using the learned patterns component (at block 514) may operate/execute until the user 524 is no longer needed to provide feedback for a “G” number of repeated iterations, which indicates there is no longer a need for active learning to improve correctness and/or accuracy.

In view of the foregoing components of FIGS. 1-5, consider the following examples of structural incorrectness (e.g., example 1) and semantic incorrectness (e.g., example 2).

In example 1 depicting a structural incorrectness, a rule generated may indicate a minimum (“min”) age of a person(s) is at least 18 years of age (e.g., min_age(x,18) and a maximum (“max”) age of 120 years of age (e.g., max_age(x,120)). The rule may be corrected by the user to add “person(x)” to the incorrect rule of min_age(x,18), max_age(x,120) such as, for example:
Rule generated: min_age(x,18), max_age(x,120)
Rule corrected by the user: person(x), min_age(x,18), max_age(x,120).

In example 2 depicting a semantic incorrectness, text of a policy may indicate “Patients younger than 18 years old.” The rule generated may indicate a person and minimum age (e.g., person(x), min_age(x,18)) but fails to include the maximum age of the person and the rule may be corrected by the user to add the maximum age (e.g., person(x), min_age(x,0), max_age(x,18)) such as, for example:
Policy text: “Patients younger than 18 years old”
Rule generated: person(x), min_age(x,18)
Rule corrected by the user: person(x), min_age(x,0), max_age(x,18)

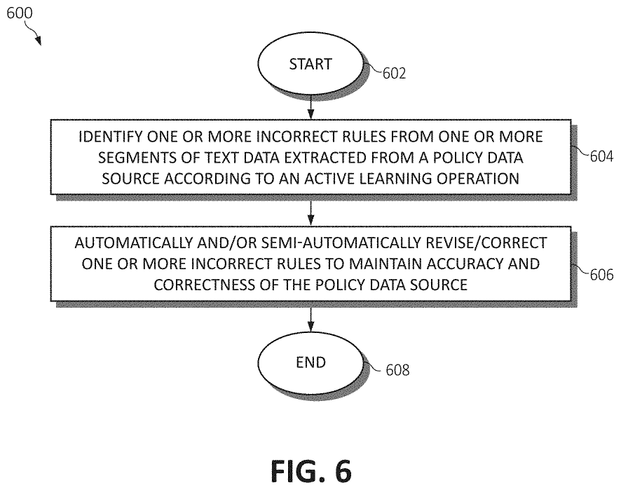

Turning now to FIG. 6, a method 600 for correcting policy data a processor is depicted, in which various aspects of the illustrated embodiments may be implemented. The functionality 600 may be implemented as a method executed as instructions on a machine, where the instructions are included on at least one computer readable medium or one non-transitory machine-readable storage medium. The functionality 600 may start in block 602.

One or more incorrect rules from one or more segments of text data extracted from a policy data source may be identified according to an active learning operation, as in block 604. The one or more incorrect rules may be automatically and/or semi-automatically revised to maintain accuracy and correctness of the policy data source, as in block 606. The functionality 600 may end, as in block 608.

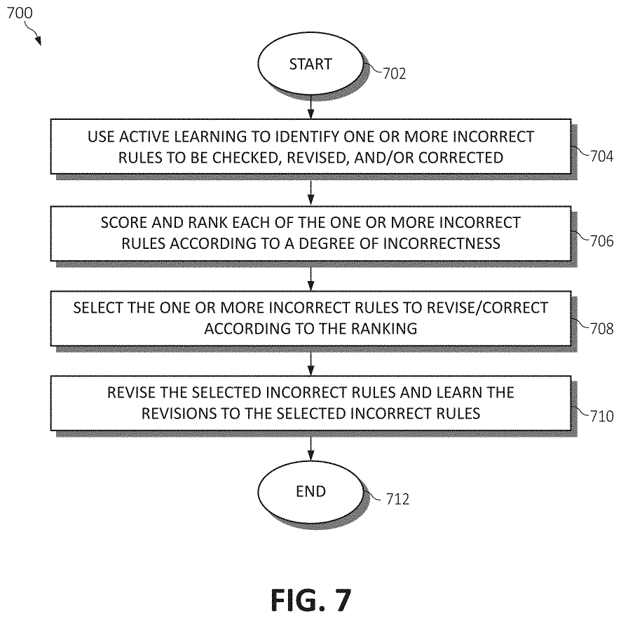

Turning now to FIG. 7, a method 700 for correcting policy data using a processor is depicted, in which various aspects of the illustrated embodiments may be implemented. The functionality 700 may be implemented as a method executed as instructions on a machine, where the instructions are included on at least one computer readable medium or one non-transitory machine-readable storage medium. The functionality 700 may start in block 702.

Active learning may be used to identify one or more incorrect rules to be checked, revised, and/or corrected, as in block 704. Each of the one or more incorrect rules may be scored and ranked according to a degree of incorrectness (as compared to one or more similar rules in a knowledge domain), as in block 706. One or more incorrect rules may be selected to revise/correct according to the ranking, as in block 708. The selected incorrect rules may be revised and the revisions to the selected incorrect rules may be learned, as in block 710. The functionality 700 may end, as in block 712.

In one aspect, in conjunction with and/or as part of at least one blocks of FIGS. 6-7, the operations of 600 and/or 700 may include each of the following. The operations of 600 and/or 700 may ingest the text data from the policy data source upon processing the text data using a lexical analysis, parsing, extraction of concepts, semantic analysis, a machine learning operation, or a combination thereof, and/or use natural language processing (NLP) to determine the set of rules from one or more segments of text data.

The operations of 600 and/or 700 may identify incorrect data relating to the one or more rules according to a knowledge domain, modify incorrect data relating to the one or more rules according to a knowledge domain, user feedback, or a combination thereof, and/or use one or more modifications to the one or more rules to revise similar rules having incorrect data.

The operations of 600 and/or 700 may collect feedback from a user for learning modifications to the one or more rules.

The operations of 600 and/or 700 may assign a score to the one or more rules indicating a probability of incorrectness and rank each of the one or more rules according to the assigned score. A machine learning mechanism may be initialized to learn, determine, or identify the incorrect data relating to the one or more rules and one or more user-provided modifications to the one or more rules, and/or to revise the one or more rules according to collected feedback from a user.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowcharts and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowcharts and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

What is claimed is:

1. A method for correcting policy data in a computing environment by a processor comprising:
revising incorrect data of one or more rules extracted from one or more segments of text data to maintain accuracy and correctness of a policy data source according to an active learning operation.

2. The method of claim 1, further including:
ingesting the text data from the policy data source upon processing the text data using a lexical analysis, parsing, extraction of concepts, semantic analysis, a machine learning operation, or a combination thereof; or
using natural language processing (NLP) to determine the set of rules from one or more segments of text data

3. The method of claim 1, further including:
identifying incorrect data relating to the one or more rules according to a knowledge domain;
modifying incorrect data relating to the one or more rules according to the knowledge domain, user feedback, or a combination thereof; or
using one or more modifications to the one or more rules to revise similar rules having incorrect data.

4. The method of claim 1, further including collecting feedback from a user for learning modifications to the one or more rules.

5. The method of claim 1, further including assigning a score to the one or more rules indicating a probability of incorrectness.

6. The method of claim 5, further including ranking each of the one or more rules according to the assigned score.

7. The method of claim 1, further including initializing a machine learning mechanism to:
learn, determine, or identify the incorrect data relating to the one or more rules and one or more user-provided modifications to the one or more rules; and
revise the one or more rules according to collected feedback from a user.

8. A system for correcting policy data in a computing environment, comprising:
one or more processors with executable instructions that when executed cause the system to:
revise incorrect data of one or more rules extracted from one or more segments of text data to maintain accuracy and correctness of a policy data source according to an active learning operation.

9. The system of claim 8, wherein the executable instructions further:
ingest the text data from the policy data source upon processing the text data using a lexical analysis, parsing, extraction of concepts, semantic analysis, a machine learning operation, or a combination thereof; or
use natural language processing (NLP) to determine the set of rules from one or more segments of text data.

10. The system of claim 8, wherein the executable instructions further:
identify incorrect data relating to the one or more rules according to a knowledge domain;
modify incorrect data relating to the one or more rules according to the knowledge domain, user feedback, or a combination thereof; or
use one or more modifications to the one or more rules to revise similar rules having incorrect data.

11. The system of claim 8, wherein the executable instructions further collect feedback from a user for learning modifications to the one or more rules.

12. The system of claim 8, wherein the executable instructions further assign a score to the one or more rules indicating a probability of incorrectness.

13. The system of claim 12, wherein the executable instructions further rank each of the one or more rules according to the assigned score.

14. The system of claim 8, wherein the executable instructions further initialize a machine learning mechanism to:
learn, determine, or identify the incorrect data relating to the one or more rules and one or more user-provided modifications to the one or more rules; and
revise the one or more rules according to collected feedback from a user.

15. A computer program product for, by one or more processors, correcting policy data in a computing environment, the computer program product comprising a non-transitory computer-readable storage medium having computer-readable program code portions stored therein, the computer-readable program code portions comprising:
an executable portion that revises incorrect data of one or more rules extracted from one or more segments of text data to maintain accuracy and correctness of a policy data source according to an active learning operation.

16. The computer program product of claim 15, further including an executable portion that:
ingests the text data from the policy data source upon processing the text data using a lexical analysis, parsing, extraction of concepts, semantic analysis, a machine learning operation, or a combination thereof; or
uses natural language processing (NLP) to determine the set of rules from one or more segments of text data.

17. The computer program product of claim 15, further including an executable portion that:
identifies incorrect data relating to the one or more rules according to a knowledge domain;
modifies incorrect data relating to the one or more rules according to the knowledge domain, user feedback, or a combination thereof; or
uses one or more modifications to the one or more rules to revise similar rules having incorrect data.

18. The computer program product of claim 15, further including an executable portion that collects feedback from a user for learning modifications to the one or more rules.

19. The computer program product of claim 15, further including an executable portion that:
assigns a score to the one or more rules indicating a probability of incorrectness; and
ranks each of the one or more rules according to the assigned score.

20. The computer program product of claim 15, further including an executable portion that initialize a machine learning mechanism to:
learns, determines, or identifies the incorrect data relating to the one or more rules and one or more user-provided modifications to the one or more rules; and
revises the one or more rules according to collected feedback from a user.
